(19) United States
(12) Patent Application Publication
(10) Pub. No.: US 2015/0142979 A1
(43) Pub. Date: May 21, 2015

(54) EQUIPMENT FOR MOBILE CLOUD COOPERATION AND SYSTEM INCLUDING THE EQUIPMENT

(71) Applicant: Electronics and Telecommunications Research Institute, Daejeon-si (KR)

(72) Inventors: Kang Chan LEE, Daejeon-si (KR); Min Kyo IN, Daejeon-si (KR); Seung Yun LEE, Daejeon-si (KR)

(21) Appl. No.: 14/538,015

(22) Filed: Nov. 11, 2014

(30) Foreign Application Priority Data
Nov. 11, 2013 (KR) 10-2013-0136485
Nov. 11, 2014 (KR) 10-2014-0155961

(51) Int. Cl. H04L 12/911; H04L 29/08

(52) U.S. Cl. CPC H04L 47/824; H04L 67/32
USPC 709/226

(57) ABSTRACT

Provided are an apparatus for mobile cloud cooperation and a system including the apparatus. The system may include a mobile device resource (MDR) user which intends to use a mobile device resource of a different mobile device; a plurality of MDR providers each of which provides one or more owned MDRs; and an MDR coordinator configured to register and manage MDRs provided by the plurality of MDR providers. In response to receiving from the MDR user a request for use of a particular MDR, the MDR coordinator allows a requested MDR among the registered MDRs to be provided to the MDR user.

### CROSS REFERENCE TO RELATED APPLICATION

This application claims priority from Korean Patent Application Nos. 10-2013-0136485, filed on Nov. 11, 2013, and 10-2014-0155961, filed on Nov. 11, 2014, in the Korean Intellectual Property Office, the disclosures of which are incorporated herein by references in its entirety.

### BACKGROUND

1. Field

The present invention relates to cloud computing, and more particularly, to an apparatus for cooperation among mobile devices in a mobile cloud computing environment, and a system including the apparatus.

2. Description of the Related Art

Simply speaking, “cloud computing” is the use of as many computing resources from a cloud server as needed via the Internet (online), wherein various and huge amount of IT resources are gathered in the cloud server. Cloud computing allows service providers as well as users to share various IT resources, such as networks, servers, storages, and the like. Generally, data has been stored and processed in such a manner that each of individual devices manages its own IT resources independently, thus there have been difficulties in data sharing and interoperability between devices. However, the introduction of cloud computing enables connection between a fixed terminal, for example, a desktop computer, and a mobile device, such as a smartphone, a table PC, and the like. Cloud computing involves elements for supporting various services. For example, cloud computing involves factors for supporting Software as a Service (SaaS), Infra as a Service (IaaS), Platform as a Service (PaaS), Device as a Service (DaaS), and the like.

Cloud computing enables users to use among IT resources as many computing resources as they want via the Internet (online) anywhere, anytime, wherein the IT resources are shared on a server of a cloud service provider. Hence, seamless access to a server of a cloud service provider via the Internet is a prerequisite for cloud computing. In addition, all requests from a cloud service user and corresponding responses from the service providers may be transmitted and received over the Internet through data exchange, that is, packet exchange, between a user device and each service provider.

With the growing distribution of portable mobile devices, such as smartphones and tablet computers, the importance of providing an environment that allows various types of mobile devices to perform the same job, that is, an environment that allows the user to execute the same job regardless of the type of currently available device is growing. Therefore, mobile cloud computing, which is a step up from typical computing that utilizes individual mobile terminals, has gained increased attention. A mobile cloud is an evolving application of the general concept of cloud computing to wireless terminals, whereby a server of a cloud service provider consists of resources that the mobile devices possess, that is, mobile device resources.

Each individual possessing a particular mobile device readily utilizes the features of the device he or she owns, and expects to be provided with a diversity of contents and services that take into account the individual's characteristics and propensities. To meet such expectations, a variety of services targeting personal users have been introduced; such as data storing and sharing services, data streaming services, usage of high-performance software, and the like. In particular, as services which were once available only at fixed location have become available even in transit, the combination of such advanced services and mobile cloud computing is expected to become a reality.

### SUMMARY

The present invention is to provide an apparatus for mobile cloud cooperation and a system that includes the apparatus which enables a user to conveniently receive mobile device resources (MDRs) by minimizing the connections between the MDR user and MDR providers.

The present invention is to provide an apparatus for mobile cloud cooperation and a system that includes the apparatus which is capable of effectively utilizing high-computing performance and various functions of other mobile devices.

In one general aspect, there is provided a system for mobile cloud coordination, including: a mobile device resource (MDR) user which intends to use a mobile device resource of a different mobile device; a plurality of MDR providers each of which provides one or more owned MDRs; and an MDR coordinator configured to register and manage MDRs provided by the plurality of MDR providers, wherein, in response to receiving from the MDR user a request for use of a particular MDR, the MDR coordinator allows for a requested MDR among the registered MDRs to be provided to the MDR user.

In one general aspect, the MDR coordinator may be configured to operate based on a Coordination Description Language (CDL) that describes a series of details that are required for coordination for the mobile cloud cooperation. In addition, the CDL may include a mobile device identifier, a mobile device resource identifier, and a mobile device resource authorization description.

In another general aspect, the MDR coordinator may include: a CDL storage configured to include: a CDL registered by the MDR user and information on registered CDLs that are provided by the plurality of MDR providers; a CDL verifier configured to verify context of a CDL to be registered in the CDL storage; a CDL analyzer configured to analyze the request from the MDR user; a CDL analyzer configured to analyze the request from the MDR user; a CDL dispatcher configured to deliver the request from the MDR user to one or more of the plurality of MDR providers according to an analysis by the CDL analyzer; and a CDL result collector configured to receive an execution result from the one or more MDR providers that have received the request from the CDL dispatcher and to forward the received execution result to the requesting MDR user. In this case, the MDR coordinator further may further include a CDL execution engine configured to determine, in a case where the request from the MDR user relates to multiple MDRs, the MDR providers to provide the requested multiple MDRs; and/or a mobile list provider configured to provide the MDR user with a list of the MDR providers. Also, the MDR coordinator may further include a recommender configured to recommend a sample CDL to the MDR user.

In another general aspect, there is provided a mobile device resource (MDR) coordinator for registering and managing MDRs that are provided by a plurality of MDR providers, and providing the registered MDRs to an MDR user, the MDR coordinator including: a CDL storage configured to store coordination description languages that have been registered by the MDR user and information about the registered MDRs that are provided by the plurality of MDR providers; a CDL verifier configured to verify syntax of a CDL to be registered in the CDL storage; a CDL analyzer configured to analyze a request from the MDR user; a CDL dispatcher configured to deliver the request from the MDR user to one or more of the plurality of MDR providers according to an analysis by the CDL analyzer; and a CDL result collector configured to receive an execution result from the one or more MDR providers that have received the request from the CDL dispatcher, and forward the received execution result to the requesting MDR user.

The MDR coordinator may further include a CDL execution engine configured to determine, in a case where the request from the MDR user relates to multiple MDRs, the MDR providers to provide the requested multiple MDRs, and/or a mobile list provider configured to provide the MDR user with a list of the plurality of MDR providers. Also, the MDR coordinator may further include a recommender configured to recommend a sample CDL to the MDR user.

Other features and aspects will be apparent from the following detailed description, the drawings, and the claims.

### BRIEF DESCRIPTION OF THE DRAWINGS

FIG. 1 is a diagram illustrating an example of general mobile cloud cooperation in a mobile cloud environment.

FIG. 2 is a diagram illustrating an example of a system for mobile cloud cooperation according to an exemplary embodiment.

FIG. 3 is a block diagram illustrating an example of a configuration of a MDR coordinator of FIG. 2.

FIG. 4 is a flowchart illustrating an example of Coordination Description Language (CDL) registration process as a method for mobile cloud cooperation according to an exemplary embodiment.

FIG. 5 is a flowchart illustrating an example of CDL execution process as a method for mobile cloud cooperation according to an exemplary embodiment.

FIG. 6 is a flowchart illustrating another example of CDL execution process as a method for mobile cloud cooperation according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Mobile cloud cooperation enables a particular mobile device to search for mobile device resource (MDR) of another mobile device and deliver or provide the found MDR to yet another mobile device to use. Hereinafter, a mobile device that offers its own mobile device resource to another mobile device will be referred to as an “MDR provider” or simply a “resource provider,” and a mobile device that receives and uses the MDR of the other mobile device will be referred to as an “MDR user” or simply a “resource user.”

In a mobile cloud environment, for an MDR user to receive a particular MDR from an MDR provider, a designated process for resource request generally needs to be executed through a direct association established between the MDR user and the MDR provider. For example, the designated process may include a resource authorization step, a resource authorization search step, available-resource-list provision step, a resource use request step, and a resource provision step. In another example, the designated process for resource request may include a mobile device search step, a mobile device response step, a resource authorization request step, a resource authorization step, a resource use request step, and a resource provision step. As such, in order to use an MDR, the resource user must go through the necessary procedures, such as receiving authentication approved by the resource provider for use of resources. In addition, in order to ensure exclusive use of the resources only by the authenticated users, the aforementioned complicated procedures should be undertaken even for one-time use.

The mobile resources are seldom used only once, but are mostly used for connected tasks, such as a workflow. Using one mobile resource once is referred to as a transaction, whereby a number of transactions are grouped together into a set and used. For example, for mobile cloud cooperation, like a case in which content has been downloaded, a plurality of mobile resources are requested and provided according to a workflow, or in this case, a particular viewer is launched and, if necessary, an editor application is executed for editing the content.

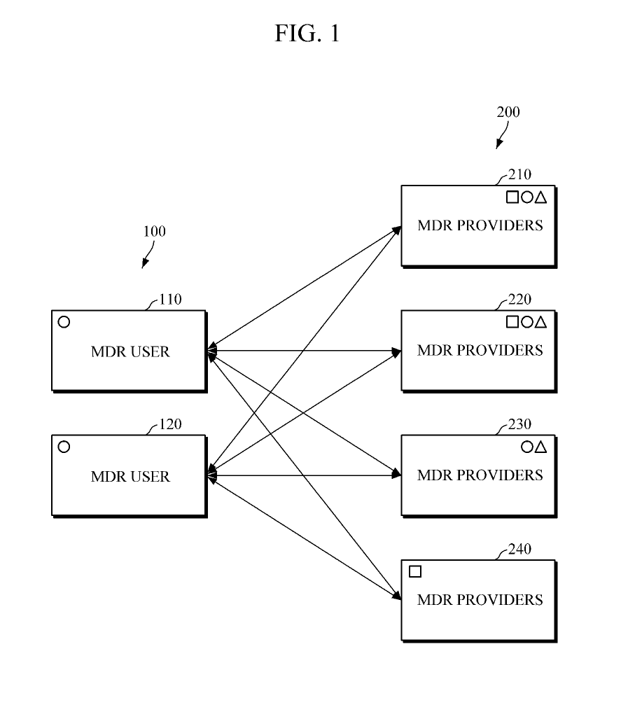

FIG. 1 is a diagram illustrating an example of general mobile cloud cooperation in which an MDR user 100 is provided with an MDR by an MDR provider 200 and uses the MDR in a mobile cloud environment. In the general mobile cloud cooperation, a system is configured to allow multiple resource users 110 and 120 to be directly connected to multiple resource providers 210, 220, 230, and 240 individually so as to trade resources therebetween. Referring to FIG. 1, in a general mobile cloud cooperation environment or system, each of the ‘m’ number of MDR users (m is 2 in FIG. 1) is directly connected to each of the ‘n’ number of MDR providers (n is 4 in FIG. 1), enabling the cooperation between mobile devices.

In the general MDR environment as illustrated in FIG. 1, when one MDR user 110 uses MDRs from multiple MDR providers, for example, n MDR providers 210, 220, 230, and 240, the MDR user 110 should require n connections, which are as many as the MDR providers. Thus, if MDRs are to be used by connecting all of m MDR users 110 and 120 to a total of n MDR providers 210, 220, 230, and 240, n*m connections are required.

Additionally, the connection described herein is not simply limited to a communication connection between two mobile devices. More specifically, in order to set each connection, placing a resource request to the MDR provider 200 for the MDR user 100 to use an MDR f is required. Here, this resource request process may include one of the two series of the following steps: 1. resource authorization, resource authorization search, provision of a list of available resources, resource use request, and provision of resources; 2. mobile device search, mobile device response, resource authorization request, resource authorization, resource use request, and provision of resource. Hence, the mobile cloud cooperation, that is, the cooperation among mobile devices, in the general mobile cloud environment as shown in FIG. 1, inevitably requires a more complex, detailed process than illustrated in FIG. 1.

In addition, in the system for mobile cloud cooperation of FIG. 1, the MDR users need to understand all information about MDRs that can be provided by the multiple MDR providers, so that it can timely issue a request for a necessary MDR and use it.

To overcome the drawbacks described above, which are caused during the mobile cloud cooperation in a general mobile cloud environment, the embodiment of the present disclosure further provides a coordination function that enables the search, recommendation, and use of MDRs by placing an MDR coordinator between the MDR user and the MDR provider. A device with the coordination function registers and manages MDRs provided by the multiple MDR providers, and, in response to a request for use of a particular MDR from an MDR user, enables the MDR user to be provided with an MDR that is the most suitable for the user's request among the registered and managed MDRs.

The mobile cloud cooperation, with the help of such a resource coordinator, may prevent the inconvenience of having to seek a different resource provider for connection with the MDR user each time a mobile resource is required, and also enable efficient search and use an MDR of interest, a process which will be described in detail below. In addition, the resource user does not need to have all information (for example, which type and what characteristics of MDR a particular resource provider can offer, and the like) about all resource providers.

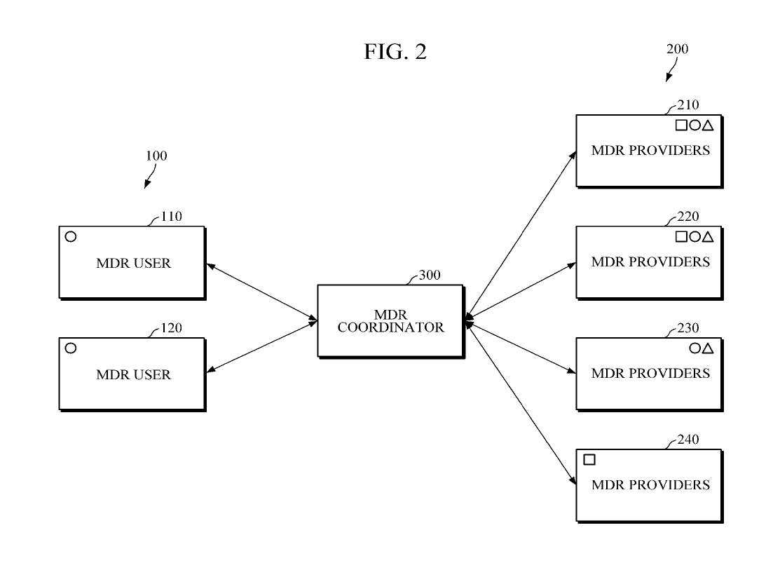

FIG. 2 is a diagram illustrating an example of a system for mobile cloud cooperation according to the exemplary embodiment, in which an MDR user 100 uses an MDR provided from an MDR provider 200. The system for mobile cloud cooperation is configured to have an MDR coordinator 300 or simply a resource coordinator interposed between multiple resource users 110 and 120 and multiple resource providers 210, 220, 230, and 240, wherein the MDR coordinator 300 or the resource coordinator provides coordination for the searching, recommending, and using of MDRs. Referring to FIG. 2, the mobile cloud system includes a total of m (m is 2 in FIG. 2) MDR users 100, a total of n (n is 4 in FIG. 2) MDR providers 200, and the MDR coordinator 300.

The resource coordinator 300 is not simply an intermediary that mediates request and provision of resources between the resource users 100 and the resource providers 200. In the embodiment, the resource coordinator 300 interposed between one or more resource users 100 and the multiple resource providers 200 operate to appear to resource users 110 and 120 as a single group of resource providers that have all intended resources, and to appear to each of the resource providers 210, 220, 230, and 240 as the only resource user that has requested the MDR.

In the embodiment, the resource coordinator 300 operates in a predetermined format or language that can efficiently describe information required for cooperation in a mobile cloud environment, for example, acquisition and authentication of usage rights, provision request and transfer of resources, fee-charge, and the like. The predetermined format or language describes a series of contents required for mobile cloud cooperation in a text format, and may be a coordination description language (CDL).

For example, the CDL may be utilized to describe and register in advance relevant information that is required when the resource provider 200 provides an MDR. Also, the CDL may be utilized to register, in the MDR coordinator 300, relevant information that is required when the resource user 100 uses an MDR. When the resource users 100 proceed with a predetermined resource request process in order to request the resource providers 200 for MDRs, the utilization of the CDL may enable efficient cooperation in the mobile cloud environment by minimizing the message exchange between the resource users 100 and the resource providers 200 via the resource coordinator 300. In addition, the resource users 100 do not have to retain any information about the resource providers 200.

The CDL used to facilitate efficient cooperation between the resource users 100 and the resource providers 200 with the help of the resource coordinator 300 may include at the least the following information or descriptions to contain these information:
Mobile device identifier: information to identify each mobile device
Mobile device resource identifier: information to identify a mobile device resource. Designated identification information may be set in advance in each of the available MDRs.
Mobile device resource authorization description: User-related information (for example, ID, password, and the like) about a user of an MDR offered by an MDR provider, description of usage rights (for example, duration of use, such as permanent or single use, available hours to use, such as 24 hours or only specific hours, and a range of permitted use, such as an exclusive permission for a single user or a permission of use that includes third parties).

In addition, the resource coordinator 300 which has stored the CDLs as described above receives a request from the resource user 100 using the CDL. In response to the request, the resource coordinator 300 delivers request-related information to the resource providers 200 using the CDL, and then in response to the request, the resource providers 200 provides all necessary resources to the resource coordinator 300. Through a series of processes between the resource user 100 and the resource providers 200, the resource coordinator 300 coordinates the reuse of mobile resources or the mobile cloud cooperation.

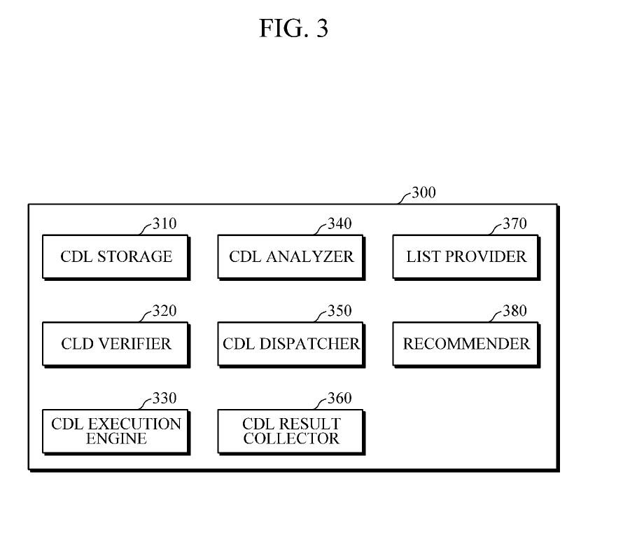

FIG. 3 is a block diagram illustrating an example of a configuration of a MDR coordinator 300 to perform the functions described above. Referring to FIG. 3, the resource coordinator 300 includes a CDL storage 310, a CLD verifier 320, a CDL execution engine 330, a CDL analyzer 340, a CDL dispatcher 350, and a CDL result collector 360. In addition, the resource coordinator 300 may further include a list provider 370 and/or a recommender 380. The elements of the resource coordinator 300 illustrated in FIG. 3 are logically distinguished from one another based on their functionality, and two or more elements may be physically integrated into one functional module, or implemented separately. Moreover, the resource coordinator 300 may not need to include all of the elements 310 to 380 illustrated in FIG. 3 for substantial implementation, while in some embodiments, the resource coordinator 300 may be implemented with only some elements.

The CDL storage 310 stores CDLs. According to the exemplary embodiment, the method of storing CDLs in the CDL storage 310 is not limited to any in particular. For efficient storage, the CDLs are stored in the CDL storage 310 for either each user or for each available resource as is shown in one of the embodiments. Alternatively, in another embodiment, the CDL storage 310 may store a CDL for each mobile device associated with the resource user 100 (referring to FIG. 2) and/or for each mobile device associated with the resource providers 200 (referring to FIG. 2).

Furthermore, the CDL storage 310 may store a CDL list and/or CDL samples. As described later, the CDL list includes information about mobile resources provided by each resource provider, as well as information about all resource providers 210, 220, 230, and 240 that are registered in the resource coordinator 300.

The CDL verifier 320 verifies the syntax of the CDL. For example, the CDL verifier 320 may verify whether or not the CDL stored in the CDL storage 310 is written in compliance with the predefined syntax. In another example, the CDL verifier 320 may verify whether various requests received from the resource user 100 or results of requests received from the resource providers 200 are written in compliance with the predefined syntax.

The CDL execution engine 330 processes the request or response written in CDL according to a method specified by the CDL. For example, the CDL execution engine 330 analyzes the request from the resource user 100 and exchanges signals with other elements of the resource coordinator 300 such that the other elements process the request based on the analysis.

In the event where the CDL analyzer receives a request for a particular resource from the resource user 100, the CDL analyzer 340 inspects or verifies whether a resource provider 200 capable of providing the requested resource or a resource provider 200 suitable for providing the requested resource is present or not. To this end, the CDL analyzer 340 may utilize information about the resource provider 200 stored in the CDL storage 310. If there are a number of resource providers 200 that can provide the requested resource, the CDL analyzer 340 may simultaneously classify the available resource providers 200 according to a fixed criterion (for example, performance or price).

The CDL dispatcher 350 delivers descriptions of CDL to each resource provider 200 to process the CDL. More specifically, the CDL dispatcher 350 may deliver a request described in CDL to a particular resource provider 200 using information about the resource provider 200 that is delivered from the CDL analyzer 340. To this end, the CDL dispatcher 340 may additionally select from among the service-available resource providers 200 obtained by the analysis of the CDL analyzer 340 an optimal resource provider 200 to process the request from the resource user 100. Criteria according to which the CDL dispatcher 340 selects the optimal resource provider 200 may be included in the request described in CDL or may have been previously specified (for example, in order of highest to lowest performance or in order of lowest to highest charge).

The CDL result collector 360 receives an execution result as a response from the resource provider 200 and forwards the result to the resource user 100. The response details may vary according to the request. For example, if the request relates to the use of a particular hardware (for example, a camera), the execution result may be data or files obtained by utilizing the hardware. In another example, if the request relates to the use of a particular application (for example, a photo editing application), the execution result may be an outcome (edited photo) of executing the application.

The list provider 370 provides a list of resource providers 200 to the resource user 100. This is to allow the resource user 100 to identify which resource provider 200 is capable of providing an MDR of interest. The provided list may be classified according to resource provider and/or available resources. Along with the list of resource providers 200, characteristic information (for example, performance, service available time, etc.) of available resources may also be offered.

The recommender 380 recommends a specific CDL or a sample CDL which provides descriptions functions that are similar to a keyword input by the user. For example, when receiving an MDR name of interest or a keyword regarding information about MDR from the resource user 100, the recommender 380 may recommend to the resource user 100 a specific CDL or sample CDL that describes the request for the pertinent resource. By doing so, even when the resource user 100 has little knowledge of or is unfamiliar with CDLs, the resource user 100 may be able to request a resource of interest and use it by utilizing the specific CDL or sample CDL that is recommended by the recommender 380.

Hereinafter, a method for implementing mobile cloud cooperation by utilizing the MDR coordinator 300 shown in FIG. 3 will be described. The method for implementing mobile cloud cooperation may be largely divided into two processes. The first process is a CDL registration process in which the resource user specifies an MDR intended for use or creates a CDL for each MDR and transmits the CDLs to the resource coordinator 300. The second process is a CDL execution process in which an explicit request and/or a resource user's request stored in the process of CDL registration is delivered to the resource providers and responses to the request are delivered to the resource user from each resource provider.

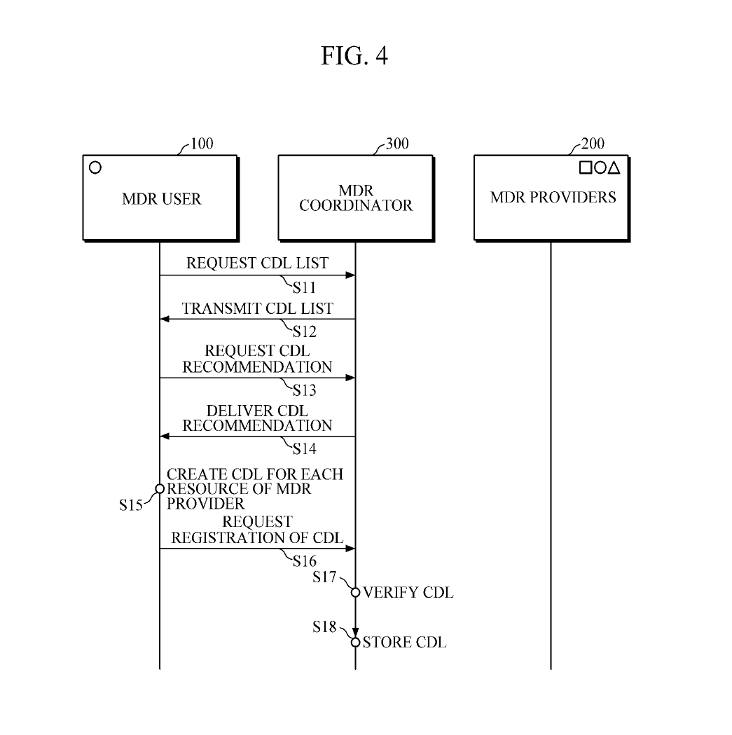

FIG. 4 is a flowchart illustrating a method for mobile cloud cooperation according to an exemplary embodiment, showing an example of a CDL registration process by the MDR user 100.

Referring to FIGS. 3 and 4, the MDR user 100 may request the MDR coordinator 300 for a CDL list for CDL registration in S11. In response to the request, the resource coordinator 300, more specifically, the list provider 370 transmits the requested CDL list to the resource user 100 in S12. The requested CDL list may be stored in the CDL storage 310 of the resource coordinator 300. The request process in S11 and provision of the CLD list in S12 are optional for CDL registration, and may thus be omitted.

The resource user 100 may request the resource coordinator 300 for CDL recommendation request for CDL registration in S13. The resource coordinator 300, more specifically, a recommender 380 that has received the CDL recommendation request, provides CDL recommendations to the resource user 100 in S14. The CDL recommendations may be provided in the form of a list, like a CDL list, which is provided only for purpose of example. Information for CDL recommendations may be stored in the CDL storage 310 of the resource coordinator 300. The CDL recommendation request process in S13 and the recommendation provision process in S14 are optional, and may thus be omitted.

The resource user 100 generates a CDL for each resource of each MDR provider 200 in S15. To this end, the resource user 100 may utilize the CDL list received in S12 and/or utilize the CDL recommendations provided in S14, and the information to be utilized is not limited thereto. In addition, the resource user 100 may generate the CDL by utilizing the CDL list or CDL recommendation, but if there is not an appropriate CDL list or CLD recommendation, the resource user 100 may create a CDL by itself. In addition, the resource user 100 transmits a CDL registration request for registering the CDL to the resource coordinator 300 in S16. The CDL registration request includes the CDL created in S15.

Then, in S17, the resource coordinator 300 verifies the CDL that is contained in the CDL registration request received in S16. The verification of CDL may be carried out by the CDL verifier 320 of the resource coordinator 300. Once the verification is complete, the resource coordinator 300 stores the received CDL in the CDL storage 310 in S18.

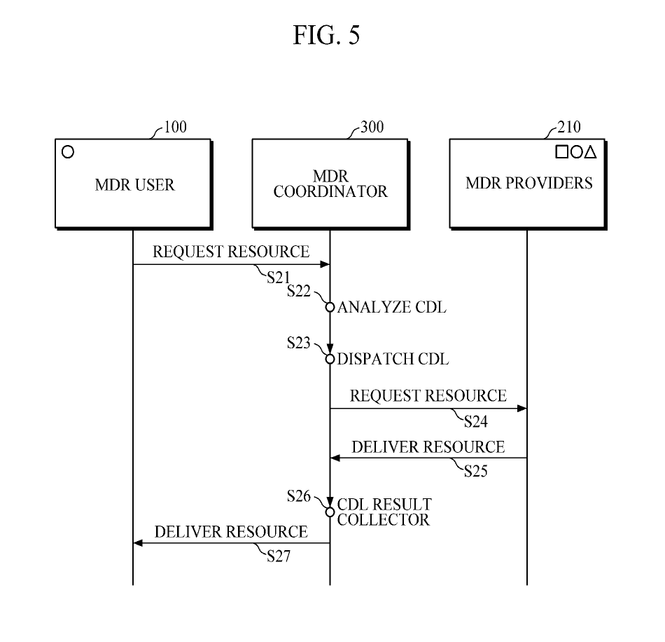

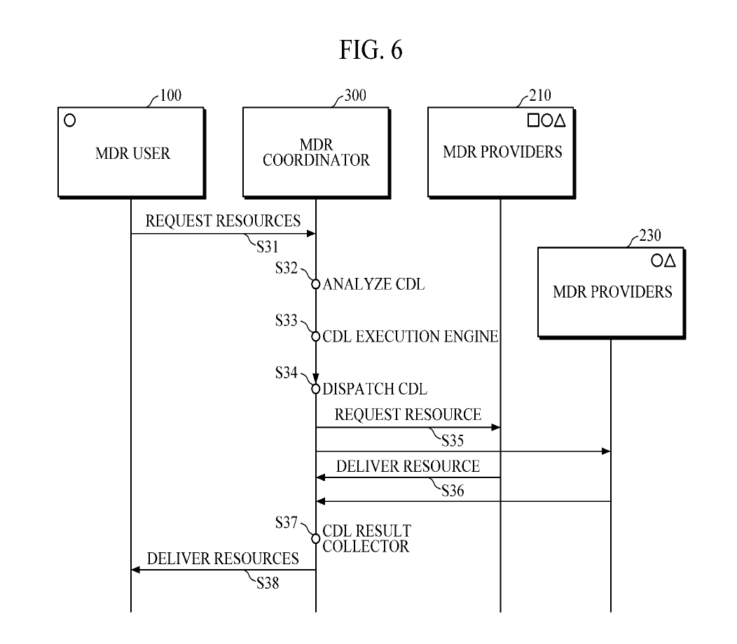

FIG. 5 and FIG. 6 are flowcharts illustrating other examples of a method for mobile cloud cooperation: FIG. 5 illustrates a CDL execution process performed by the mobile device resource provider 200 when there is only one MDR requested, and FIG. 6 illustrates a CDL execution process performed by the mobile device resource provider 200 when multiple MDRs are requested.

Referring to FIGS. 3 and 5, the mobile device resource user 100 delivers a request for an MDR, that is, a resource request CDL, to the MDR coordinator 300 in S21. In this case, as described above, only one MDR has been requested. Then, the resource coordinator 300, more specifically, the CDL analyzer 340, which has received the resource request CDL analyzes the received CDL in S22. Based on the analysis result from the CDL analyzer 340, it may be determined which resource provider is to be called upon for to provide the resource of interest among the plurality of resource providers. Then, information about the determined resource provider 210 is transmitted to the resource coordinator 300, more specifically, the CDL dispatcher 350 in S23, and the CDL dispatcher 350 delivers the resource request to the resource provider 210 determined by the CDL analyzer 340 in S24. The resource provider 210 that has received the resource request delivers the requested resource to the resource coordinator 300 in S25. The resource delivered to the resource coordinator 300 may be collected by the CDL result collector 360 in S26. Thereafter, the resource coordinator 200 forwards the resource received in S25 to the resource user 100 in S27.

Referring to FIGS. 3 and 6, the MDR user 100 issues a request for MDRs, that is, the resource request CDL, to the MDR coordinator 300 in S31. In this case, as described above, two or more MDRs have been requested. FIG. 6 illustrates an example in which two or more MDRs are provided by two resource providers 310 and 330.

The resource coordinator 300, more specifically, the CDL analysis, which has received the resource request CDL analyzes the received CDL in S32. If the analysis result from the CDL analyzer 340 shows that two or more MDRs have been requested, two or more CDLs are executed through the CDL execution engine 330 in S33. Then, as a result of execution by the CDL execution engine 330, some resource providers are selected from among the plurality of MDR providers, and it is determined which resource will be requested to each of the selected MDR providers. Information on the selected resource providers 210 and 230 and information on their resources are transmitted to the resource coordinator 300, more specifically, the CDL dispatcher 350 in S34, and the CDL dispatcher 350 issues requests for a resource to each of the respective resource providers 210 and 230 that have been determined by the CDL execution engine 330 in S35. In response to receiving the resource request, each resource provider 210 and 230 delivers a requested resource to the resource coordinator 300 in S36. The resources delivered to the resource coordinator 300 may be collected by the CDL result collector 360 in S37. Then, the resource coordinator 300 forwards the resources, which have been delivered in S36, to the resource user 100 in S38.

With the proliferation of mobile applications and advancement of cloud computing, the potential value of related cloud services is increasing, and the cloud services are expected to become a new growth engine for the future IT sector. In addition, as mobile devices have evolved into higher-speed and larger-capability devices, resources of such high-specification, high-performance devices may need to be reused. The aforementioned system for mobile cloud cooperation has an MDR coordinator which is interposed between one or more resource users and a plurality of resource providers. To a resource user, this MDR coordinator seems as if it were a resource provider that has all resources of interest, while to each resource provider it seems as if it were the only resource user that has requested an MDR. Therefore, a direct association between each resource user and each resource provider or verification of authentication is not required. In addition, by using the aforementioned apparatus and method for mobile cloud cooperation, it is possible to maximize the utilization of MDRs. Furthermore, it is also possible to apply the exemplary embodiments described above to mobile-based businesses that have not yet been provided by cloud services.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for mobile cloud coordination, comprising:
a mobile device resource (MDR) user which intends to use a mobile device resource of a different mobile device;
a plurality of MDR providers each of which provides one or more owned MDRs; and
an MDR coordinator configured to register and manage MDRs provided by the plurality of MDR providers,
wherein, in response to receiving from the MDR user a request for use of a particular MDR, the MDR coordinator allows for a requested MDR among the registered MDRs to be provided to the MDR user.

2. The system of claim 1, wherein the MDR coordinator is configured to operate based on a Coordination Description Language (CDL) that describes a series of details that are required for coordination for the mobile cloud cooperation.

3. The system of claim 2, wherein the CDL comprises a mobile device identifier, a mobile device resource identifier, and a mobile device resource authorization description.

4. The system of claim 1, wherein the MDR coordinator comprises: a CDL storage configured to comprise:
a CDL registered by the MDR user and information on registered CDLs that are provided by the plurality of MDR providers;
a CDL verifier configured to verify context of a CDL to be registered in the CDL storage; a CDL analyzer configured to analyze the request from the MDR user;
a CDL analyzer configured to analyze the request from the MDR user;
a CDL dispatcher configured to deliver the request from the MDR user to one or more of the plurality of MDR providers according to an analysis by the CDL analyzer; and
a CDL result collector configured to receive an execution result from the one or more MDR providers that have received the request from the CDL dispatcher and to forward the received execution result to the requesting MDR user.

5. The system of claim 4, wherein the MDR coordinator further comprises a CDL execution engine configured to determine, in a case where the request from the MDR user relates to multiple MDRs, the MDR providers to provide the requested multiple MDRs.

6. The system of claim 4, wherein the MDR coordinator further comprises a mobile list provider configured to provide the MDR user with a list of the MDR providers.

7. The system of claim 4, wherein the MDR coordinator further comprises a recommender configured to recommend a sample CDL to the MDR user.

8. A mobile device resource (MDR) coordinator for registering and managing MDRs that are provided by a plurality of MDR providers, and providing the registered MDRs to an MDR user, the MDR coordinator comprising:
a CDL storage configured to store coordination description languages that have been registered by the MDR user and information about the registered MDRs that are provided by the plurality of MDR providers;
a CDL verifier configured to verify syntax of a CDL to be registered in the CDL storage;
a CDL analyzer configured to analyze a request from the MDR user;
a CDL dispatcher configured to deliver the request from the MDR user to one or more of the plurality of MDR providers according to an analysis by the CDL analyzer; and
a CDL result collector configured to receive an execution result from the one or more MDR providers that have received the request from the CDL dispatcher, and forward the received execution result to the requesting MDR user.

9. The MDR coordinator of claim 8, further comprising:
a CDL execution engine configured to determine, in a case where the request from the MDR user relates to multiple MDRs, the MDR providers to provide the requested multiple MDRs.

10. The MDR coordinator of claim 8, further comprising:
a mobile list provider configured to provide the MDR user with a list of the plurality of MDR providers.

11. The MDR coordinator of claim 8, further comprising:
a recommender configured to recommend a sample CDL to the MDR user.
